(19) United States
(12) Patent Application Publication
(10) Pub. No.: US 2023/0339771 A1
(43) Pub. Date: Oct. 26, 2023

(54) A METHOD FOR PREPARING A POSITIVE ELECTRODE ACTIVE MATERIAL FOR RECHARGEABLE LITHIUM ION BATTERIES

(71) Applicant: UMICORE, Brussels (BE)

(72) Inventors: KwonSun SUN, Chungcheongnam-do (KR); SeungHwan LEE, Chungcheongnam-do (KR); Maxime BLANGERO, Chungcheongnam-do (KR); Bernard TONNON, Brussels (BE); Liang ZHU, Brussels (BE); JiHye KIM, Chungcheongnam-do (KR)

(21) Appl. No.: 17/904,309

(22) PCT Filed: Feb. 17, 2021
(86) PCT No.: PCT/EP2021/053813

§ 371 Date: Aug. 16, 2022

Related U.S. Application Data
(60) Provisional application No. 62/977,501, filed on Feb. 17, 2020.

(30) Foreign Application Priority Data
Feb. 18, 2020 (EP) 20157841.6
May 14, 2020 (WO) PCT/EP2020/063466

(51) Int. Cl. C01G 53/00; H01M 10/0525

(52) U.S. Cl. CPC C01G 53/006; H01M 10/0525; C01P 2006/40; C01P 2004/61; C01P 2006/80

(57) ABSTRACT

A powderous positive electrode active material for lithium ion secondary battery having particles comprising Li, M, and O, said particles having a Li/M molar ratio superior or equal to 0.98 and inferior or equal to 1.10, said powderous positive electrode active material being characterized in that said powder has a flow index of at least 0.10 and at most 0.30 when said powder has a D50 of at least 4.0 μm and of at most 6.0 μm or said powder has a flow index of at least 0.10 and of at most 0.20 when said powder has a D50 superior to 6.0 μm and of at most 10.0 μm, wherein the D50 is the median particle size of the powder.

### TECHNICAL FIELD AND BACKGROUND

This invention relates to a process for preparing a powderous positive electrode active material for lithium ion secondary battery. The powderous positive electrode active material has particles comprising Li, M, and O, wherein M consists in:
Co in a content x superior or equal to 5.0 mol % and inferior or equal to 40.00 mol %,
Mn in a content y superior or equal to 5.0 mol % and inferior or equal to 40.00 mol %,
A in a content c superior or equal to 0.01 mol % and inferior or equal to 2.00 mol %, wherein A comprises at least one element of the group consisting of at least one of the elements: W, Al and Si,
D in a content z superior or equal to 0 mol % and inferior or equal to 2.00 mol %, wherein D comprising at least one element of the group consisting of: Mg, Al, Nb, Zr, B, W, and Ti, and
Ni in a content of (100-x-y-c-z) mol %.

The particles have a Li/M molar ratio superior or equal to 0.98 and inferior or equal to 1.10.

In particular, the powderous positive electrode active material comprises particles having a general formula: LiaNi_{1-x-y-c-z}CoₓMn_{y}D_{z}O_{d} and bearing at least one oxide of A, A being present in said powder in a content superior or equal to 0.01 mol % and inferior or equal to 2.00 mol %, wherein 0.98≤a≤1.10, 0.05≤x≤0.40, 0.00≤y≤0.40, 0.00≤z≤0.02, and 1.80≤d≤2.20.

The process comprises the steps of:
Preparing a first powder mixture comprising a lithium source, a nickel source, a cobalt source, a manganese source and optionally, a source of D,
firing the mixture of powder at a temperature of at least 300° C. and at most 1000° C. to obtain an agglomerated fired body,
grinding the agglomerated fired body so as to obtain the aforementioned powderous positive electrode active material.

In the framework of the present invention, the step of firing the powder through a heat treatment process is applied to generate an agglomerated fired body. The agglomerated fired body is therefore a product resulting from the aforementioned firing process and has an agglomerated shape comprising particles which are assembled together to form a (collection of) cluster(s) of particles having a predetermined median size. The aforementioned cluster(s) can be dissembled in a powder having a lower median size than that of the agglomerated fired body.

Such a process to prepare such a powderous positive electrode active material is already known, for example from the document WO2019185349 (referenced hereafter as WO'349).

A drawback of the process according to WO'349 is that the step of grinding the agglomerated fired body to obtain the powderous positive electrode active material has a low throughput. This step of grinding is essential because it allows either to convert the agglomerated fired body into a powderous positive electrode active material as an intermediate product, said intermediate product being further processed so as to obtain a final powderous positive electrode active material product, or to disintegrate agglomerated clusters of particles constituting a powderous positive electrode active material final product so as to meet targeted particle sizes and specific distribution thereof. Moreover, the integration of the final powderous positive electrode active material product in the cathode requires a casting step which is optimized if a powder has no agglomeration in the slurry dispersion.

This low throughput, which is related to a low flowability of the powderous positive electrode active material, eventually leads to a low production rate (i.e. a low ratio of the quantity of the powderous positive electrode active material produced and the time spent producing it).

It should be noted that flowability can usually not be improved by more intensive milling. Rather the reverse is the case, finer powders typically have a worse flowability than coarser, but otherwise similar powders.

Indeed, the low flowability of the causes a bottleneck effect which leads to a reduction of the capacity of the entire manufacturing process of said positive electrode material. The results of having a bottleneck in manufacturing process are stalls in production, supply overstock, and pressure from customers.

Presently, there is therefore a need to design a powderous positive electrode active material having an improved controlled flowability, thereby achieving a process for manufacturing said powderous positive electrode active material with higher throughput.

By a powderous positive electrode active material having an improved flowability, it must be understood a powderous positive electrode active material having a flow index FI, said FI being for instance measured according to the method described in Section 1.4, of: 0.10≤FI≤0.30 when 4.0 μm≤D50≤6.0 μm or of: 0.10≤FI≤0.225 when 6.0 μm≤D50≤10.0 μm, wherein D50 is defined as the median particle size of said powderous positive electrode active material (and is expressed in μm).

A positive electrode active material is defined as a material which is electrochemically active in a positive electrode. By active material, it must be understood a material capable to capture and release Li ions when subjected to a voltage change over a predetermined period of time.

In this document the flow index is defined as the slope of a straight line fitted by the least squares method to experimental results of measured unconfined failure strengths at several principal consolidating stresses as measured in an annular shear cell of 6 inch diameter and with a volume of 230 cm³.

The flow index is measured on the Brookfield PFT Powder flow tester, which is a well-known and dominant equipment for measuring a powder flow index, using the standard software provided by the manufacturer and using the standard settings in this software of a torsional speed of 1 revolution per hour and a axial speed of 1 mm/sec.

### SUMMARY OF THE INVENTION

The objective of designing a powderous positive electrode active material having a flowability index FI of :0.10≤FI≤0.30 when 4.0 μm≤D50≤6.0 μm or of : 0.10≤FI≤0.20 when 6.0 μm<D50≤10.0 μm, wherein D50 is defined as the median particle size of said powderous positive electrode active material, is met by providing a process according to claim 1. The process according to claims 1 allows to control the flowability index of the powderous positive electrode active material manufactured therefrom.

It is indeed observed that the improved flowability indexes, as illustrated in the results in Table 9, are achieved for powderous positive electrode active materials obtained from a processes according to EX1, EX2, and EX3.1. The powderous positive electrode active material according to EX1.1, EX1.2, EX2.1, EX2.2, EX3.1, and EX3.2 indeed show a flow index value of 0.30 when 4.0 μm≤D50≤6.0 μm and a flow index value of ≤0.20 when 6.0 μm<D50≤10.0 μm.

The present invention concerns the following embodiments:

### EMBODIMENT 1

In a first aspect, the present invention concerns a process of producing a powderous positive electrode active material for lithium ion secondary battery having particles comprising Li, M, and O, wherein M consists in:
Co in a content x superior or equal to 5.0 mol % and inferior or equal to 40.00 mol %,
Mn in a content y superior or equal to 5.0 mol % and inferior or equal to 40.00 mol %,
A in a content c superior or equal to 0.01 mol % and inferior or equal to 2.00 mol %, wherein A comprises at least one element of the group consisting of at least one of the elements: W, Al and Si,
D in a content z superior or equal to 0 mol % and inferior or equal to 2.00 mol %, wherein D comprising at least one element of the group consisting of: Mg, Al, Nb, Zr, B, W, and Ti, and
Ni in a content of (100-x-y-c-z) mol %. said particles having a Li/M molar ratio superior or equal to 0.98 and inferior or equal to 1.10, the process comprising the steps of:
   Preparing a mixture of powder comprising a lithium source, a nickel source, a cobalt source, a manganese source and optionally, a source of D,
   firing the mixture of powder at a temperature of at least 300° C. and at most 1000° C. to obtain an agglomerated fired body,
   grinding the agglomerated fired body so as to obtain the powderous positive electrode active material, said process being characterized in that a source of at least one of the elements: W, Al, and Si is grinded together with the agglomerated fired body.

Optionally, the process according to the Embodiment 1 is characterized in that a source of either one of the elements: W, Al, or Si is grinded together with the agglomerated fired body.

Preferably, the powderous positive electrode active material has a median particle size D50 which is at least 4.0 μm and which is at most 10.0 μm, more preferably at most 9.0 μm and even more preferably at most 8.0 μm.

Preferably the step of grinding the agglomerated fired body is executed in an air classifying mill.

For completeness it is noted that in this document the source of at least one of the elements: W, Al, and Si means a source external to the agglomerated fired body.

### EMBODIMENT 2

In a second embodiment, preferably according to the Embodiment 1, the source of A is a nanometric size oxide powder.

Nanometric size powder means a powder having particle median size of less than 1.0 μm and superior or equal to 1.0 nm.

### EMBODIMENT 3

In a third embodiment, preferably according to the Embodiment 1 or 2, the source of aluminum is Al₂O₃.

### EMBODIMENT 4

In a fourth embodiment, preferably according to the Embodiment 1 or 2, the source of silicon is SiO₂.

### EMBODIMENT 5

In a fifth embodiment, preferably according to any of the preceding Embodiments, the source of tungsten is WO₃.

### EMBODIMENT 6

In a sixth embodiment, preferably according to any of the preceding Embodiments, the Ni-based precursor is at least one compound selected from the group consisting of: Ni-based oxide, Ni-based hydroxide, Ni-based carbonate, or Ni-based oxyhydroxide.

### EMBODIMENT 7

In a seventh embodiment, preferably according to any of the preceding Embodiments, the lithium source is at least one compound selected from the group consisting of: Li₂CO₃, Li₂CO₃·H₂O, LiOH, LiOH·H₂O or Li₂O.

### EMBODIMENT 8

In an eight embodiment, preferably according to any of the preceding Embodiments 3 to 7, wherein the source of aluminum added in the grinding step so as to obtain a molar content of aluminum which is superior or equal to 0.08 mol % and inferior or equal to 1.50 mol %, with respect to the sum of the molar contents of Ni, Mn, and Co in the agglomerated fired body.

### EMBODIMENT 9

In a ninth embodiment, preferably according to any of the preceding Embodiments 4 to 7, the source of silicon added in the grinding step in a molar content of silicon which is superior or equal to 0.36 mol % and inferior or equal to 1.45 mol %, with respect to the total molar contents of Ni, Mn, and Co in the agglomerated fired body.

### EMBODIMENT 10

In a tenth embodiment, preferably according to any of the preceding Embodiments 5 to 7, wherein the source of tungsten added in the grinding step so as to obtain a molar content of tungsten which is superior or equal to 0.20mol % and inferior or equal to 0.35 mol %, with respect to the sum of the molar contents of Ni, Mn, and Co in the agglomerated fired body.

### EMBODIMENT 11

In a second aspect, the present invention covers a powderous positive electrode active material for lithium ion secondary battery having particles comprising Li, M, and O, wherein M consists in:
Co in a content x superior or equal to 5.0 mol % and inferior or equal to 40.00 mol %,
Mn in a content y superior or equal to 5.0 mol % and inferior or equal to 40.00 mol %,
A in a content c superior or equal to 0.01 mol % and inferior or equal to 2.00 mol % wherein A comprising at least one element of the group consisting of: W, Al, and Si,
D in a content z superior or equal to 0 mol % and inferior or equal to 2.00 mol %, wherein D comprising at least one element of the group consisting of: Mg, Al, Nb, Zr, B, W, and Ti, and

Ni in a content of (100-x-y-c-z) mol %. said particles having a Li/M molar ratio superior or equal to 0.98 and inferior or equal to 1.10, said powderous positive electrode active material being characterized in that said powder has a flow index FI of: 0.10≤FI≤0.30 when 4.0≤D50≤6.0 or of 0.10≤FI≤0.225 when 6.0<D50≤10.0, wherein D50 is defined as the median particle size in micrometers (μm).

Preferably, D50 is of least 4.0 μm and at most 10.0 μm, more preferably at most 9.0 μm and even more preferably at most 8.0 μm.

Preferably 0.10≤FI≤0.20 when 6.0<D50≤8.0.

The flow index of the powderous positive electrode according to the second aspect of the invention is of at least 0.10 and of at most 0.30.

The FI of a solid state powder is acceptable at the value of at least 0.10. The powder with FI inferior to 0.10 will be liquid-like thus flowing uncontrollably fast.

In optional embodiments, the powder according to the Embodiment 11 has a flow index FI of:
0.10≤FI≤0.30 when 4.5 μm≤D50≤6.0 μm, or
0.10≤FI≤0.30 when 4.0 μm≤D50≤5.0 μm, or
0.10≤FI≤0.30 when 4.5 μm≤D50≤5.0 μm, or
0.15≤FI≤0.30 when 4.0 μm≤D50≤6.0 μm, or
0.20≤FI≤0.30 when 4.0 μm≤D50≤6.0 μm, or
0.10≤FI≤0.25 when 4.0 μm≤D50≤6.0 μm, or
0.15≤FI≤0.25 when 4.0 μm≤D50≤6.0 μm, or
0.15≤FI≤0.30 when 4.5 μm≤D50≤6.0 μm, or
0.15≤FI≤0.25 when 4.5 μm≤D50≤5.5 μm, or
0.10≤FI≤0.20 when 6.0 μm<D50≤8.0 μm, or
0.15≤FI≤0.20 when 6.0 μm<D50≤8.0 μm, or
0.10≤FI≤0.20 when 7.0 μm<D50≤8.0 μm, or
0.15≤FI≤0.20 when 7.0 μm<D50≤8.0 μm.

In another aspect the invention concerns a process and materials as defined by the clauses mentioned below.

Clause 1. A process for producing a boron and tungsten bearing powderous positive electrode active material for lithium ion secondary battery having particles comprising Li, M, and O, wherein M consists in:
Co in a content x superior or equal to 5.0 mol % and inferior or equal to 35.00 mol %,
Mn in a content y superior or equal to 0 mol % and inferior or equal to 35.00 mol %,
Zr in a content m superior or equal to 0 mol % and inferior or equal to 2.00 mol %,
B in a content b superior or equal to 0.01 mol % and inferior or equal to 2.00 mol %,
W in a content c superior or equal to 0.01 mol % and inferior or equal to 2.00 mol %,
a dopant A in a content z superior or equal to 0 mol % and inferior or equal to 2.00mol %, wherein A comprising at least one element of the group consisting of: Mg, Al, Nb, and Ti, and
Ni in a content of (100-x-y-m-b-c) mol %, said particles having a Li/M molar ratio superior or equal to 0.98 and inferior or equal to 1.10, the process comprising the steps of:
mixing a Ni-based precursor, a source of Li, and optionally a source of Zr and A, so as to obtain a first mixture,
sintering the first mixture at a first temperature of at least 700° C. and at most 1000° C. to obtain a first sintered body,
grinding the first sintered body so as to obtain a crushed powder,
mixing the crushed powder and a source of boron to obtain a second mixture,
heat-treating the second mixture at a second temperature of at least 300° C. and at most 750° C., said process being characterized in that a source of tungsten is grinded together with the first sintered body so as to obtain a crushed powder comprising tungsten.

In the framework of clause 1, the step of sintering the first mixture is defined as a step of heating the first mixture so as to generate a sintered body from the first mixture. The sintered body is therefore a product resulting from the sintering process and having a chemical composition that is distinct from that of the first mixture (i.e. before sintering).

Clause 2. The process according to clause 1, wherein the source of tungsten is a nanometric size powder, wherein nanometric size powder means a powder having W-based particles having a particle median size of less than 1 μm and superior or equal to 1 nm.

Clause 3. The process according to clause 2, wherein the source of tungsten is WO₃.

Clause 4. The process according to any of the preceding clauses, wherein the source of boron is H₃BO₃.

Clause 5. The process according to any of the preceding clauses, wherein the Ni-based precursor is at least one compound selected from the group consisting of: Ni-based oxide, Ni-based hydroxide, Ni-based carbonate, or Ni-based oxyhydroxide.

Clause 6. The process according to any of the preceding clauses, wherein the source of lithium is at least one compound selected from the group consisting of: Li₂CO₃, Li₂CO₃H₂O, LiOH, LiOHH₂O or Li₂O.

Clause 7. The process according to any of the preceding clauses, wherein the source of zirconium is at least one compound selected from the group consisting of: ZrO₂, ZrO, ZrC, ZrN, Zr(OH)₄, Zr(NO₃)₄, or ZrSiO₄.

Clause 8. The process according to any of the preceding clauses, wherein the first sintering temperature is of at least 700° C., preferably of at least 800° C., more preferably of at most 880° C.

Clause 9. The process according to clause 8, wherein the second mixture is heat treated at a second temperature is of at least 300° C., preferably of at least 350° C., more preferably of at most 400° C.

Clause 10. The process according to any of the preceding clauses, wherein the source of tungsten is added in the grinding step in a weight content of the tungsten superior or equal to 4000 ppm and inferior or equal to 6000 ppm, with respect to the weight of the sintered body.

Clause 11: The process according to any of the preceding clauses, wherein the crushed powder obtained in the step of grinding the first sintered body has a median particle size D50 which is at least 4.0 μm and which is at most 10.0 μm, more preferably at most 9.0 μm and even more preferably at most 8.0 μm.

Clause 12: The process according to any of the preceding clauses, wherein the step of grinding the first sintered body is executed in an air classifying mill.

Clause 13. A powderous positive electrode active material for lithium ion secondary battery having particles comprising Li, M, and O, wherein M consists in:
Co in a content x superior or equal to 5.0 mol % and inferior or equal to 35.00 mol %,
Mn in a content y superior or equal to 0 mol % and inferior or equal to 35.00 mol %,
Zr in a content m superior or equal to 0 mol % and inferior or equal to 2.00 mol %,
B in a content b superior or equal to 0.01 mol % and inferior or equal to 2.00 mol %,
W in a content c superior or equal to 0.01 mol % and inferior or equal to 2.00 mol %,
a dopant A in a content z superior or equal to 0 mol % and inferior or equal to 2.00 mol %, wherein A comprising at least one element of the group consisting of: Mg, Al, Nb, and Ti, and
Ni in a content of (100-x-y-m-b-c) mol %,
   said particles having a Li/M molar ratio superior or equal to 0.98 and inferior or equal to 1.10, said powderous positive electrode active material being characterized in that said particles have a w_{1/}(w₁+w₂) ratio >0.40, as measured by XANES, wherein w₁ is the wt % of Li₂WO₄ contained in the active material and w₂ is the wt % of WO₃ contained in the active material.

Clause 14. The powderous positive electrode active material according to clause 13, having a molar ratio of Li₂WO₄ (w₁) with respect to the total molar content of Li₂WO₄ (w₁) and WO₃ (w₂) of at least 0.45, preferably of at least 0.50, more preferably of at most 1.00.

Clause 15. The powderous positive electrode active material according to clause 13 or 14, comprising particles have a general formula: LiₐNi_{1-x-y-m-z}CoₓMn_{y}ZrₘB_{b}W_{c}A_{z}O_{d}, wherein 0.99≤a≤1.10, 0.05≤x≤0.35, 0.00≤y≤0.35, 0.00≤m≤0.02, 0.0001≤z≤0.02, 0.0001≤b≤0.02, 0.0001≤c≤0.02, and 1.80≤d≤2.20.

Clause 16. The powderous positive electrode active material according to any of clauses 13 to 15, wherein the particles have a composition comprising:
a first phase belonging to the R-3m space group and having a general formula: LiₐNi_{1-x-y-m-z}CoₓMn_{y}ZₘB_{b}W_{c}A_{z}O_{d}, wherein 0.99≤a≤1.10, 0.05≤x≤0.35, 0.00≤y≤0.35, 0.00≤m≤0.02, 0.0001≤z≤0.02, 0.0001≤b≤0.02, 0.0001≤c≤0.02, and 1.80≤d≤2.20,
a second phase having a general formula Li₂WO₄ and belonging to the R-3 space group, and
a third phase having a general formula WO₃ and belonging to the P21/n space group.

Clause 17: The powderous positive electrode active material according to any of clauses 13 to 16, having a median particle size D50 which is at least 4.0 μm and which is at most 10.0 μm, more preferably at most 9.0 μm and even more preferably at most 8.0 μm.

Clause 18. A powderous precursor compound for manufacturing the powderous positive electrode active material according to any of the clauses 13 to 17, the precursor having particles comprising Li, M, and O, wherein M consists in:
Co in a content x superior or equal to 5.00 mol % and inferior or equal to 35.00 mol %,
Mn in a content y superior or equal to 0 mol % and inferior or equal to 35.00 mol %,
Zr in a content m superior or equal to 0 mol % and inferior or equal to 2.00 mol %,
W in a content c superior or equal to 0.01 mol % and inferior or equal to 2.00 mol %,
a dopant A in a content z superior or equal to 0 mol % and inferior or equal to 2.00 mol %, wherein A comprising at least one element of the group consisting of: Mg, Al, Nb, and Ti, and
Ni in a content of (100-x-y-m-c) mol %, said particles having a Li/M molar ratio superior or equal to 0.98 and inferior or equal to 1.10, said powderous precursor having a powder flow index of inferior to 0.20, and preferably of superior to 0.10.

### BRIEF DESCRIPTION OF THE FIGURES

FIG. 1: Image of a Powder Flow Tester (PFT)

FIG. 2: Schematic representation of a trough as a part of a PFT

FIG. 3: Schema of the preparation steps of EX1.1 according to this invention

FIG. 4: Schema of the preparation steps of EX2.1 according to this invention

FIG. 5: Schema of the preparation steps of EX2.1 according to this invention

FIG. 6: Graph of the relationship between D50 (x-axis) obtained from particle size distribution measurement and the flow index FI (y-axis) of EXs and CEXs

### DETAILED DESCRIPTION

In the drawings and the following detailed description, preferred embodiments are described in detail to enable practice of the invention. Although the invention is described with reference to these specific preferred embodiments, it will be understood that the invention is not limited to these preferred embodiments. But to the contrary, the invention includes numerous alternatives, modifications and equivalents as will become apparent from consideration of the following detailed description and accompanying drawings.

The invention is further illustrated in the following examples:

### 1. Description of Analysis Methods

### 1.1. Coin Cell Test

### 1.1.1. Coin Cell Preparation

For the preparation of a positive electrode, a slurry containing a positive electrode active material powder P, a conductor C (Super P, Timcal (Imerys Graphite & Carbon), http://www.imerys-graphite-and-carbon.com/wordpress/wp-app/uploads/2018/10/ENSACO-150-210-240-250-260-350-360-G-ENSACO-150-250-P-SUPER-P-SUPER-P-Li-C- NERGY-SUPER-C-45-65-T V-2.2 -USA-SDS.pdf), a binder B (KF#9305, Kureha,

https://www.kureha.co.jp/en/business/material/pdf/KFpolymer_BD_en.pdf)—with a P:C:B formulation of 90:5:5 by weight-, and a solvent (NMP, Mitsubishi, https://www.m-chemical.co.jp/en/products/departments/mcc/c4/product/1201005_7922.html), is prepared by using a high-speed homogenizer. The homogenized slurry is spread on one side of an aluminum foil using a doctor blade coater with a 230 μm gap. The slurry-coated foil is then dried in an oven at 120° C. for 30 minutes and then pressed using a calendaring tool. The calendaring pressed slurry-coated foiled is dried again in a vacuum oven for 12 hours to completely remove the remaining solvent in the electrode film. A coin cell is assembled in an argon-filled glovebox. A separator (Celgard® 2320, Arora, P., & Zhang, Z. (John). (2004). Battery Separators. Chemical Reviews, 104(10), 4419-4462) is located between the positive electrode and a piece of lithium foil used as a negative electrode. 1M LiPF6 in EC:DMC (1:2<vol. %>) is used as electrolyte and is dropped between the separator and the electrodes. Thereafter, the coin cell is completely sealed to prevent leakage of the electrolyte.

### 1.1.2. Testing Method

Each coin cell is cycled at 25° C. using a Toscat-3100 computer-controlled galvanostatic cycling stations (from Toyo, http://www.toyosystem.com/image/menu3/toscat/TOSCAT-3100.pdf). The coin cell testing procedure uses a 1C current definition of 160 mA/g and comprises the following three parts:

Part I is about the evaluation of the rate performances of the positive electrode active material powder at 0.1C, 0.2C, 0.5C, 1C, 2C and 3C in a 4.3-3.0 V/Li metal window range. With the exception of the 1st cycle during which the initial charge capacity (CQ1) and the discharge capacity (DQ1) are measured in constant current mode (CC), all subsequent cycles feature a constant current-constant voltage during the charge, with an end current criterion of 0.05C. A rest time (between each charge and discharge) of 30 minutes for the first cycle and 10 minutes for all subsequent cycles is allowed.

The irreversible capacity IRRQ is expressed in % as follows:

$$IRRQ ( \% ) = \frac{( CQ 1 - DQ 1 )}{CQ 1} \times 100$$

Part II is the evaluation of the cycle life at 1C. The charge cut-off voltage is set at 4.5V/Li metal. The discharge capacity at 4.5V/Li metal is measured at 0.1C at cycles 7 and 34; and at 1C at cycles 8 (DQ8) and 35 (DQ35). The first capacity fading, QF1C, is calculated as follows:

$$QF 1 C = ( 1 - \frac{DQ 35}{DQ 8} ) \times \frac{10000}{27} in \% / 100 cycles$$

Part III is the evaluation of cycle life at 1C (i.e. with 1C charging rate). The charge cut-off voltage is set at 4.5V/Li metal. The discharge capacity at 4.5V/Li metal is measured at 1C at cycles 36 and 60. The second capacity fading, QF1C1C, is calculated as follows:

$$QF 1 C 1 C = ( 1 - \frac{DQ 60}{DQ 36} ) \times \frac{10000}{24} in \% / 100 cycles$$

Table 1 below summarizes the above-mentioned three parts:

TABLE 1
Cycling schedule for coin cell testing

| | | Charge | | | | Discharge | | | |
|---|---|---|---|---|---|---|---|---|---|
| | Cycle | | End | Rest | V/Li | | End | Rest | V/Li |
| Type | No | C Rate | current | (min) | metal (V) | C Rate | current | (min) | metal (V) |
| Part I | 1 | 0.10 | — | 30 | 4.3 | 0.10 | — | 30 | 3.0 |
| | 2 | 0.25 | 0.05 C | 10 | 4.3 | 0.20 | — | 10 | 3.0 |
| | 3 | 0.25 | 0.05 C | 10 | 4.3 | 0.50 | — | 10 | 3.0 |
| | 4 | 0.25 | 0.05 C | 10 | 4.3 | 1.00 | — | 10 | 3.0 |
| | 5 | 0.25 | 0.05 C | 10 | 4.3 | 2.00 | — | 10 | 3.0 |
| | 6 | 0.25 | 0.05 C | 10 | 4.3 | 3.00 | — | 10 | 3.0 |
| Part II | 7 | 0.25 | 0.10 C | 10 | 4.5 | 0.10 | — | 10 | 3.0 |
| | 8 | 0.25 | 0.10 C | 10 | 4.5 | 1.00 | — | 10 | 3.0 |
| | 9~33 | 0.50 | 0.10 C | 10 | 4.5 | 1.00 | — | 10 | 3.0 |
| | 34 | 0.25 | 0.10 C | 10 | 4.5 | 0.10 | — | 10 | 3.0 |
| | 35 | 0.25 | 0.10 C | 10 | 4.5 | 1.00 | — | 10 | 3.0 |
| Part III | 36-60 | 1.00 | — | 10 | 4.5 | 1.00 | — | 10 | 3.0 |

* “—” means that no end current is applied (i.e. the measurement is made under constant current mode)

### 1.3. Powder Flowability Test

The powder flowability test is conducted with a Brookfield Powder Flow Tester (PFT) equipped with a Powder Flow Pro Software (Brookfield Engineering Laboratories, Inc., https://www.brookfieldengineering.com/products/powder-flow-testers/pft-powder-flow-testers).

The measurement test is performed according to the standard test method described in the Brookfield powder flow tester Operating Instruction Manual No. M09-1200-F1016 page 16-19 and page 27-30 (https://www.brookfieldengineering.com/products/powder-flow-testers/-/media/b58fc1f1e4414d3a8e3b80683d5438e7.ashx).

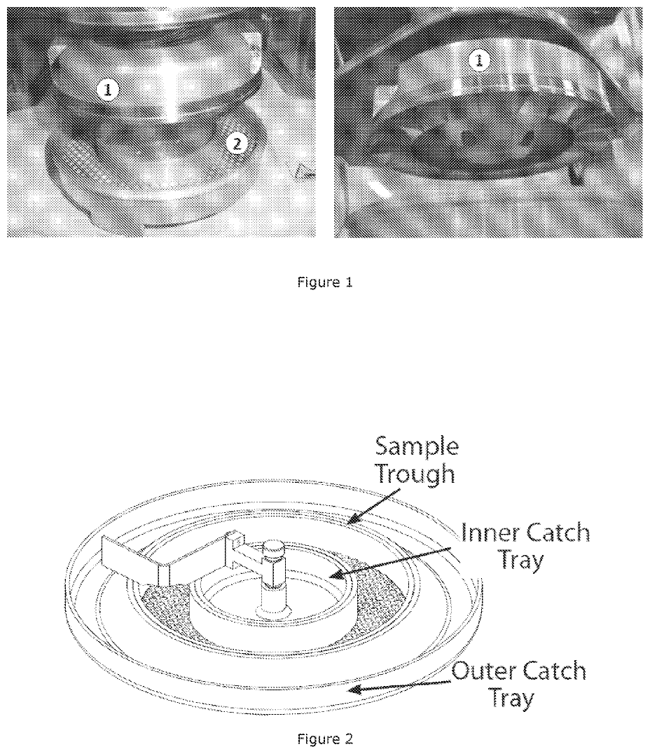

Pictures of the PFT equipment used for conducting the PFT test are provided in FIG. 1. The equipment includes a vane lid (\textcircled{1}) and a trough (\textcircled{2}). The trough has a diameter of 6-inch with a volume of 230 cc and the vane lid has a diameter of 6-inch and a volume of 33 cc.

The test is performed according to the above-described standard test method defined as follows:

Step a) The trough is cleaned with a pressured air gun and weighed before filling it with a sample material.

Step b) The powder is scooped into the clean trough. This Step b is followed by the Steps c to g:

Step c) An inner catch tray equipped with a shaping blade and an outer catch tray is fixed to the trough. A schematic representation of the (inner and outer) catch trays and the trough is provided in FIG. 2. The inner and outer catch trays are destined to contain the excess powder spillage from the powder provided in the trough, said excess powder spillage being created during a shaping step (cfr. Step d below).

Step d) The powder is shaped, meaning is evenly distributed in the trough by rotating the shaping blade.

Step e) The catch trays are removed, and the weight of the sample material powder in the trough is then determined by subtracting the weight of the cleaned empty trough from the weight of the trough loaded with the shaped sample material powder.

Step f) The weight of the shaped sample material powder in the trough is inputted into the Brookfield Powder Flow Pro software (https://www.brookfieldengineering.com/products/software/powder-flow-pro), and the flowability test is initiated by implementing the consecutive Steps g).a. to g).e.:

Steps g) The principle of operation of the PFT (FIG. 1) consists in:
a. Driving the vane lid (reference \textcircled{1} in FIG. 1) vertically downward into the powder sample contained in the trough (reference \textcircled{2} in FIG. 1).
b. Rotating the trough at a defined rotation speed defined as follows: 1.0 mm/sec axial speed and 1.0 rev/hour torsional speed, and the torque resistance of the powder in the trough moving against the powder in a stationary lid (number \textcircled{2} in FIG. 1) is measured by a calibrated reaction torque sensor.
c. Five compression steps (or also called principal consolidating stress σ₁, expressed in KPa), each of these steps having a predetermined intensity |σ₁| (x axis). For each of these compression steps, a specific torque (of an intensity |σ_{c}|-y axis) is applied to the powder by rotating the trough. This specific torque is expressed as the unconfined failure strength (σ_{c}, expressed in KPa).
d. Recording with a computer the σ_{c} strength responses to five different σ₁ stresses applied to the powder. These responses are then plotted in a σ₁ (x-axis) versus σ_{c} (y-axis) curve according to the measurement result in Tables 2-9.

### CEX1:

TABLE 2
The applied σ₁ (x-axis) and the σ_{c}
response (y-axis) for CEX1

| | Principal | Unconfined |
|---|---|---|
| | consolidating | failure |
| | stress | strength |
| | \|σ₁\| | \|σ_{c}\| |
| # | (KPa) | (KPa) |
| 1 | 0.65 | 0.46 |
| 2 | 1.16 | 0.77 |
| 3 | 2.25 | 1.31 |
| 4 | 4.55 | 2.23 |
| 5 | 9.02 | 3.68 |

### EX1.1:

TABLE 3
The applied σ₁ (x-axis) and the σ_{c}
response (y-axis) for EX1.1

| | Principal | Unconfined |
|---|---|---|
| | consolidating | failure |
| | stress | strength |
| | \|σ₁\| | \|σ_{c}\| |
| # | (KPa) | (KPa) |
| 1 | 0.56 | 0.28 |
| 2 | 1.12 | 0.46 |
| 3 | 2.35 | 0.81 |
| 4 | 4.92 | 1.51 |
| 5 | 10.03 | 2.69 |

### EX1.2:

TABLE 4
The applied σ₁ (x-axis) and the σ_{c}
response (y-axis) for EX1.2

| | Principal | Unconfined |
|---|---|---|
| | consolidating | failure |
| | stress | strength |
| | \|σ₁\| | \|σ_{c}\| |
| # | (KPa) | (KPa) |
| 1 | 1.80 | 0.86 |
| 2 | 3.68 | 1.28 |
| 3 | 5.52 | 1.62 |
| 4 | 7.07 | 1.98 |
| 5 | 8.91 | 2.27 |

### CEX2:

TABLE 5
The applied σ₁ (x-axis) and the σ_{c}
response (y-axis) for CEX2

| | Principal | Unconfined |
|---|---|---|
| | consolidating | failure |
| | stress | strength |
| | \|σ₁\| | \|σ_{c}\| |
| # | (KPa) | (KPa) |
| 1 | 1.92 | 1.35 |
| 2 | 3.61 | 2.05 |
| 3 | 5.34 | 2.64 |
| 4 | 7.88 | 3.15 |
| 5 | 9.80 | 3.67 |

### EX2.1:

TABLE 6
The applied σ₁ (x-axis) and the σ_{c}
response (y-axis) for CEX2.1

| | Principal | Unconfined |
|---|---|---|
| | consolidating | failure |
| | stress | strength |
| | \|σ₁\| | \|σ_{c}\| |
| # | (KPa) | (KPa) |
| 1 | 0.57 | 0.33 |
| 2 | 1.08 | 0.49 |
| 3 | 2.21 | 0.74 |
| 4 | 4.40 | 1.22 |
| 5 | 8.77 | 1.92 |

### EX2.2:

TABLE 7
The applied σ₁ (x-axis) and the σ_{c}
response (y-axis) for CEX2.2

| | Principal | Unconfined |
|---|---|---|
| | consolidating | failure |
| | stress | strength |
| | \|σ₁\| | \|σ_{c}\| |
| # | (KPa) | (KPa) |
| 1 | 0.59 | 0.26 |
| 2 | 1.12 | 0.38 |
| 3 | 2.20 | 0.62 |
| 4 | 4.35 | 1.00 |
| 5 | 8.64 | 1.58 |

### CEX3:

TABLE 8
The applied σ₁ (x-axis) and the σ_{c}
response (y-axis) for CEX3

| | Principal | Unconfined |
|---|---|---|
| | consolidating | failure |
| | stress | strength |
| | \|σ₁\| | \|σ_{c}\| |
| # | (KPa) | (KPa) |
| 1 | 0.60 | 0.11 |
| 2 | 1.26 | 0.45 |
| 3 | 2.43 | 0.76 |
| 4 | 5.00 | 1.45 |
| 5 | 10.11 | 2.57 |

### EX3.1:

TABLE 9
The applied σ₁ (x-axis) and the σ_{c}
response (y-axis) for EX3.1

| | Principal | Unconfined |
|---|---|---|
| | consolidating | failure |
| | stress | strength |
| | \|σ₁\| | \|σ_{c}\| |
| # | (KPa) | (KPa) |
| 1 | 0.60 | 0.36 |
| 2 | 1.09 | 0.51 |
| 3 | 2.11 | 0.80 |
| 4 | 4.13 | 1.23 |
| 5 | 8.34 | 1.83 |

### EX3.2:

TABLE 10
The applied σ₁ (x-axis) and the σ_{c}
response (y-axis) for EX3.2

| | Principal | Unconfined |
|---|---|---|
| | consolidating | failure |
| | stress | strength |
| | \|σ₁\| | \|σ_{c}\| |
| # | (KPa) | (KPa) |
| 1 | 0.68 | 0.45 |
| 2 | 1.26 | 0.73 |
| 3 | 2.40 | 1.14 |
| 4 | 4.79 | 1.81 |
| 5 | 9.59 | 3.06 |

e. Calculating the flow index FI by linear fitting of the σ1 vs the σc responses plotted from c.). The resulting linear fitting equations are:

CEX1: σ_{c}=0.38×σ₁+0.36, R=0.995,

EX1.1: σ_{c}=0.25×σ₁+0.19, R=0.999,

EX1.2: σ_{c}=0.20×σ₁+0.52, R=0.998,

CEX2: σ_{c}=0.28×σ₁ +0.95, R=0.991,

EX2.1: σ_{c}=0.19×σ₁ +0.29, R=0.995,

EX2.2: σ_{c}=0.16×σ₁+0.22, R=0.994,

CEX3: σ_{c}=0.25×σ₁+0.10, R=0.995,

EX3.1: σ_{c}=0.19×σ₁+0.34, R=0.988, and

EX3.2: σ_{c}=0.29×σ₁+0.37, R=0.997.

The slope of the fitted linear line according to σ_{c}=slope×σ₁+coefficient, is the flow index which ranges from 0.0 to 1.0. As the FI approaches 0.0, the sample is more free-flowing. As the FI approaches 1.0, the sample is more cohesive. The flow index is unitless.

The R value is the correlation coefficient indicating the strength of the linear relationship between x and y variables. The value ranges from 0 to 1 where R-value approaching 1 indicates the stronger the linear relationship between x and y variables. A R value equal to 1 implies an established linear relationship between x and y variables.

### 1.5. Particle Size Distribution

The particle size distribution (psd) for non-water soluble powders like the nickel-based transition metal oxy-hydroxide powder is measured by using a Malvern Mastersizer 3000 with a Hydro MV wet dispersion accessory (https://www.malvernpanalytical.com/en/products/product-range/mastersizer-range/mastersizer-3000#overview) after having dispersed each of the powder samples in an aqueous medium. In order to improve the dispersion of the powder, sufficient ultrasonic irradiation and stirring is applied, and an appropriate surfactant is introduced.

The psd for water-soluble (like H₃BO₃) powder is measured by using a Malvern Mastersizer 3000 with an Aero S dry dispersion accessory after having dispersed the powder samples in an air medium. D50 is defined as the particle size at 50% of the cumulative volume % distributions obtained from the Malvern Mastersizer 3000 measurements.

### 2. Examples and Comparative Examples

### EXAMPLE 1

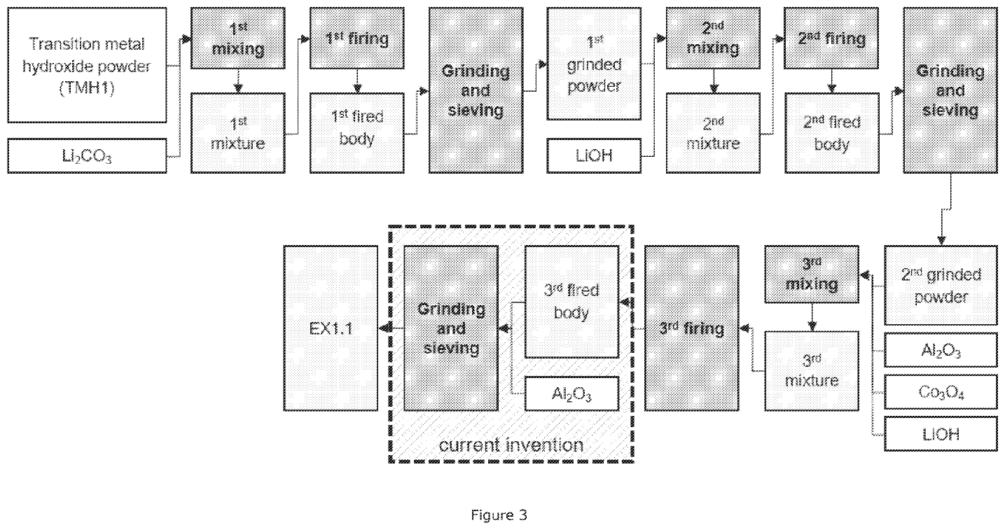

A positive electrode active material powder comprising particles having a general formula of Li_{1.02}Ni_{0.61}Mn_{0.22}Co_{0.17}O₂, the powder further comprising Al-oxide on the surface of its particles, is obtained based on a solid-state reaction between a lithium source and a transition metal-based source. The process diagram is displayed in the FIG. 3 and does run as follows:

Step 1) Metal hydroxide precursor preparation: A nickel-based transition metal hydroxide powder (TMH1) having a general formula Ni_{0.63}Mn_{0.22}Co_{0.15}(OH)₂ is prepared by a co-precipitation process in a large-scale continuous stirred tank reactor (CSTR) with mixed nickel manganese cobalt sulfates, sodium hydroxide, and ammonia.

Step 2) First mixing: the transition metal-based hydroxide precursor TMH1 powders prepared from Step 1) is mixed with Li₂CO₃ to obtain a first mixture having a lithium to metal molar ratio (Li/M) of 0.92.

Step 3) First firing: The first mixture from Step 2) is fired at 900° C. for 10 hours under an air atmosphere to obtain a first fired body.

Step 4) Grinding and sieving: the first fired body from Step 3) is grinded and sieved to produce a first grinded powder.

Step 5) Second mixing: First grinded powder from Step 4) is mixed with LiOH to produce a second mixture having a lithium to metal molar ratio (Li/M) of 1.05.

Step 6) Second firing: the second mixture from Step 5) is sintered at 933° C. for 10 hours under an air atmosphere to produce a second fired body.

Step 7) Grinding and sieving: the second fired body is grinded and sieved to produce a second grinded powder.

Step 8) Third mixing: Second grinded powder from Step 7) is mixed with 0.19 mol % Al₂O₃, 3 mol % Co₃O₄, and 3 mol % LiOH with respect to the total molar contents of Ni, Mn, and Co to produce a third mixture.

Step 9) Third firing: the third mixture from Step 8) is sintered at 775° C. for 12.3 hours under an air atmosphere to produce a third fired body.

Step 10) Grinding and sieving: the third fired body (which is the agglomerated fired body according referenced in the present invention) is inserted into a grinding and sieving equipment like air classifying mill (ACM) together with 0.09 mol % Al₂O₃ nano-powder with respect to the total molar contents of Ni, Mn, and Co (500 ppm of Al with respect to the total weight of the third fired body) and grinded together with the Al₂O₃ nano-powder to produce a third grinded powder, that is a positive electrode active material powder containing 0.56 mol % of Al and labelled as EX1.1.

EX1.1 is according to the present invention.

EX1.2 is prepared with the same method as EX1.1 except that the Al₂O₃ nano-powder amount in Step 10) is 0.19 mol % (1000 ppm of Al with respect to the total weight of the third fired body). EX1.2 contains 0.74 mol % of Al with respect to the total molar contents of Ni, Mn, and Co.

EX1.2 is according to the present invention.

### COMPARATIVE EXAMPLE 1

CEX1 is obtained through the same method as EX1.1 except that there is no addition of Al₂O₃ nano-powder during grinding in the Step 10). CEX1 contains 0.37 mol % of Al with respect to the total molar contents of Ni, Mn, and Co.

CEX1 is not according to the present invention and is according to WO'349.

### EXAMPLE 2

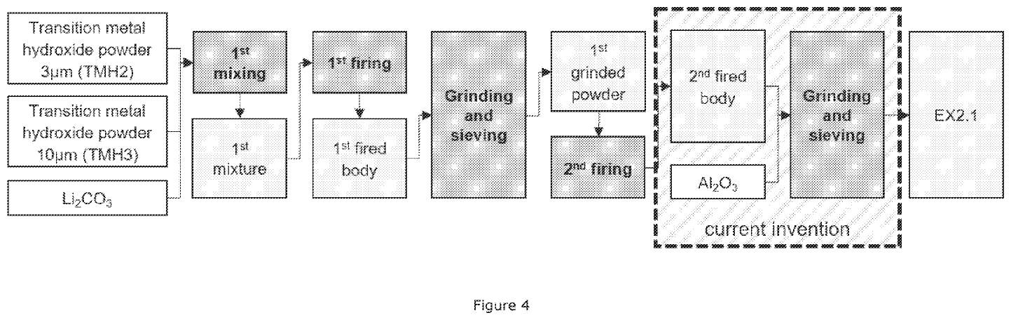

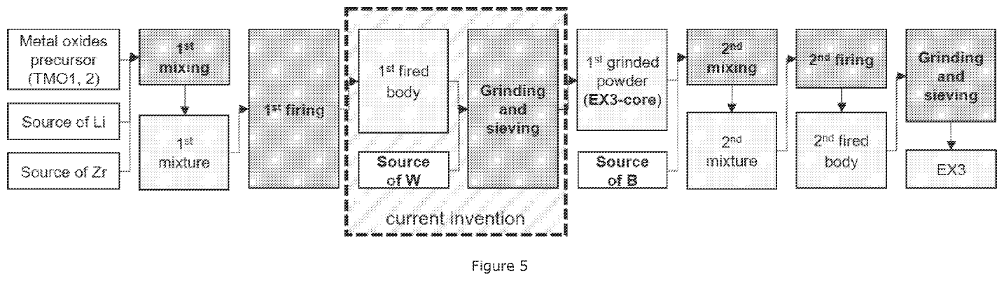

A positive electrode active material powder comprising particles having a general formula of Li_{1.075}Ni_{0.34}Mn_{0.32}Co_{0.33}O₂, the powder further comprising Al-oxide on the surface of its particles, is obtained based on a solid-state reaction between a lithium source and a transition metal-based source. The process diagram is displayed in the FIG. 4 and does run as follows:

Step 1) Metal hydroxide precursor preparation: two individual batches of nickel-based transition metal hydroxide powders characterized by two different particle sizes are prepared by a co-precipitation process in a large-scale continuous stirred tank reactor (CSTR) containing a mixture of nickel manganese cobalt sulfates, sodium hydroxide, and ammonia. The products from the two batches have the same general formula Ni_{0.342}Mn_{0.326}Co_{0.332}(OH)₂ but two different average particle sizes (D50), each are 3 μm (TMH2) and 10 μm (TMH3), respectively.

Step 2) First mixing: each of the transition metal-based hydroxide precursor TMH2 and TMH3 powders prepared from Step 1) are mixed with Li₂CO₃ to obtain a first mixture wherein the mixing ratio of TMH2 and TMH3 powders is 30%:70% by weight and the lithium to metal molar ratio (Li/M) is 1.10.

Step 3) First firing: The first mixture from Step 2) is fired at 720° C. for 2 hours under an air atmosphere to obtain a first fired body.

Step 4) Grinding and sieving: the first fired body from Step 3) is grinded and sieved to produce a first grinded powder.

Step 5) Second firing: the first grinded powder from Step 4) is fired at 985° C. for 10 hours under an air atmosphere to produce a second fired body.

Step 6) Grinding and sieving: the second fired body (which is the agglomerated fired body according referenced in the present invention) is inserted into a grinding and sieving equipment like ACM together with 0.46 mol % Al₂O₃ nano-powder with respect to the total molar contents of Ni, Mn, and Co (2500 ppm of Al with respect to the total weight of the third fired body) and grinded together with the Al₂O₃ nano-powder to produce a second grinded powder, that is a positive electrode active material powder containing 0.93 mol % of Al and labelled as EX2.1.

EX2.1 is according to the present invention.

EX2.2 is prepared with the same method as EX2.1 except that a SiO₂ nano-powder is used in Step 6). EX2.2 contains a 0.89 mol % of Si with respect to the total molar contents of Ni, Mn, and Co.

EX2.2 is according to the present invention.

### COMPARATIVE EXAMPLE 2

CEX2 is obtained through the same method as EX2.1 except no addition of Al₂O₃ nano-powder during grinding in the Step 6).

CEX2 is not according to the present invention and is according to WO'349.

### EXAMPLE 3

A NMC powder comprising particles having a general formula Li_{1.06}Ni_{0.65}Mn_{0.20}Co_{0.15}Zr_{0.00}O₂, the particles bearing at their surface W-oxide and B-oxide, is obtained based on a solid-state reaction between a lithium source and a transition metal-based source. The process diagram is displayed in the FIG. 5 and does run as follows:

Step 1) Metal oxides precursor preparation:

a. co-precipitation: two individual batches of nickel-based transition metal oxy-hydroxide powders characterized by two different particle size 0s are prepared by a co-precipitation process in a large-scale continuous stirred tank reactor (CSTR) containing a mixture of nickel manganese cobalt sulfates, sodium hydroxide, and ammonia. The products from the two batches have the same general formula Ni_{0.65}Mn_{0.20}Co_{0.15}(OH)₂ but two different average particle sizes (D50), each are 9.5 μm (TMH3) and 4.5 μm (TMH4), respectively.

b. heat treatment: TMH3 is placed on an alumina tray and heated at 425° C. for 7 hours under a flow of dry air so as to produce an oxide precursor powder labelled as TMO1. TMH4 is separately heat treated according to the same method as THM3 to produce an oxide precursor powder labelled as TMO2.

Step 2) First mixing: each of the transition metal-based oxide precursor TMO1 and TMO2 powders prepared from Step 1) is mixed with LiOH and ZrO₂ powders to obtain a first mixture. TMO1 and TMO2 powders are mixed in a 7:3 ratio by weight, the lithium to metal molar ratio is 1.03, and the Zr content in the mixture is 3700 ppm.

Step 3) First firing: The first mixture from Step 2) is sintered at 855° C. for 12 hours under an oxygen containing atmosphere to obtain a first fired body.

Step 4) Grinding and sieving: the first fired body (which is the agglomerated fired body according referenced in the present invention) is mixed with a WO₃ nano-powder (median particle size D50 of 0.18 μm) during a grinding and sieving process. The product from this grinding and sieving process is the first grinded powder containing 4500 ppm of W and labelled as EX3.1, which is an intermediate powderous positive electrode active material which is converted into EX3.2, a final powderous positive electrode active material product obtained from the treatment of EX3.1 in the Steps 5 and 6).

Step 5) Second mixing: EX3.1 from Step 4) is mixed with a H₃BO₃ powder having D50 of 4.8 μm to obtain a second mixture containing 500 ppm of B.

Step 6) Second firing: the second mixture from Step 5) is sintered at 385° C. for 8 hours under an oxygen atmosphere to obtain a second fired body. The second fired body is grinded and sieved by air classifying mill (ACM) to obtain a positive electrode active material being the EX3.2 material.

EX3.1 is according to the present invention.

### COMPARATIVE EXAMPLE 3

CEX3 is obtained through the same method as EX3.1 except that the WO₃ powder is added in the Step 5) (instead of in the Step 4)) together with H₃BO₃ powder.

CEX3 is not according to the present invention and is according to WO'349.

A flowability test according to the method in Section 1.3 is applied to the examples and comparative examples. The FI obtained for EX1.1, EX1.2, and CEX1 are 0.25, 0.20, and 0.38, respectively.

These results show that the flowability of EX1.1 is significantly improved by the addition of Al₂O₃ nano-powder in the Step 10) grinding compared to CEX1. Extra amount of Al₂O₃ nano-powder in EX1.2 slightly decreases the FI of the powder comparing to that of EX1.1.

The flow index obtained for EX2.1, EX2.2, and CEX2 are 0.19, 0.16, and 0.34, respectively.

These result show that the flowability of EX2.1 is significantly improved by the addition of Al₂O₃ in the Step 6) grinding in comparison with CEX2. An improvement of the flowability is also observed by the addition of SiO₂ nano-powders (cfr. EX2.2) in the Step 6) grinding.

The FI obtained for EX3.1, EX3.2, and EX3.3 are 0.19, 0.29, and 0.25, respectively.

These result show that the flowability of EX3.1 is significantly improved by the addition of WO₃ in the Step 4) grinding in comparison with CEX3.

So as to conclude, a lower FI number indicates an easier free-flowing characteristic of the powder, which is the goal of the invention.

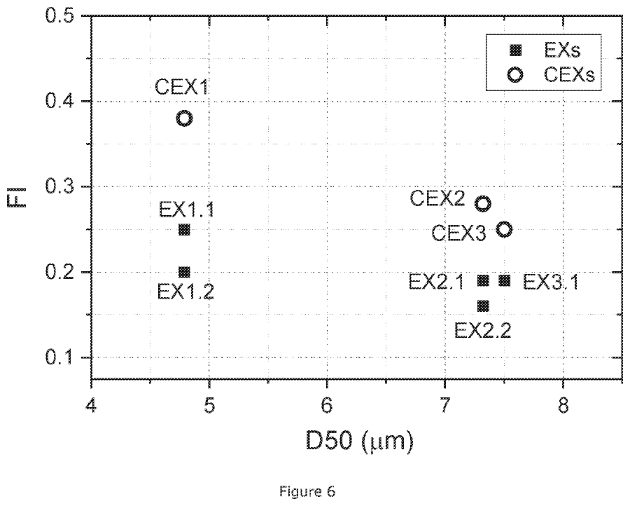

FIG. 6 showing D50 of the examples and comparative examples with their corresponding FI. Indeed, as mentioned above, a powder having FI of 0.10 to 0.30 is achieved at D50 superior or equal to 4 μm and inferior or equal to 6 μm as shown by EX1.1 and EX1.2 and FI of 0.10 to 0.22 is achieved at D50 superior to 6 μm and inferior or equal to 8 μas shown by EX2.1, EX2.2, and EX3.1. The FI of 0.10 to 0.30 at 4.0 μm D50 6.0 μm and FI of 0.10 to 0.22 at 6.0 μm <D50 8.0 μm can, for instance, be easily and then be fast transported through channels in powder transportation lines to a milling (grinding) equipment such as an ACM.

According to the aforementioned powder flowability test results, the addition of an Al, Si, or W nano-powder during grinding has the benefit to decrease the FI of the powder and improve the powder free flowing characteristic of the positive electrode active material powders.

Table 10 shows the coin cell test results of the cathode material powders according to the examples and the comparative examples. It is obvious from this table that EX1.1 and EX1.2 have a better electrochemical performance comparing to those obtained for CEX1, as indicated by a higher DQ1, lower IRRQ, and more stable fading rate indicated by lower QF1C and QF1C1C values.

EX2.1 and EX2.2 have comparable electrochemical properties to CEX2 ones, regardless of the addition of Al₂O₃ or SiO₂ nano-powders which are the non-electrochemically active materials. Therefore, the invention aiming at obtaining a positive electrode active material powder with an improved flowability is achieved without sacrificing its electrochemical performances.

TABLE 10
Summary of EX1 and CEX1 electrochemical test, sieving yield, and flowability test

| | | Process* | | | | | | | |
|---|---|---|---|---|---|---|---|---|---|
| | | | Amount of source | Coin cell | | | | PSD | Flowability |
| Example | | Source | of A | DQ1 | IRRQ | QF1C | QF1C1C | D50 | Flow |
| ID | General formula | of A | (mol %) | (mAh/g) | (%) | (%/100) | (%/100) | (μm) | index |
| CEX1 | Li_{1.02}Ni_{0.61}Mn_{0.22}Co_{0.17}O₂ | —*** | — | 173.8 | 12.66 | 9.20 | 17.51 | 4.79 | 0.41 |
| EX1.1 | Li_{1.02}Ni_{0.61}Mn_{0.22}Co_{0.17}O₂•Al₂O₃** | Al₂O₃ | 0.09 | 174.5 | 12.62 | 8.60 | 16.13 | | 0.25 |
| EX1.2 | | Al₂O₃ | 0.19 | 175.0 | 12.57 | 7.96 | 14.74 | | 0.20 |
| CEX2 | Li_{1.075}Ni_{0.34}Mn_{0.32}Co_{0.33}O₂ | — | — | 156.1 | 11.47 | 5.55 | 17.50 | 7.32 | 0.28 |
| EX2.1 | Li_{1.075}Ni_{0.34}Mn_{0.32}Co_{0.33}O₂•Al₂O₃ | Al₂O₃ | 0.93 | 156.8 | 11.01 | 6.70 | 14.31 | | 0.19 |
| EX2.2 | Li_{1.075}Ni_{0.34}Mn_{0.32}Co_{0.33}O₂•SiO₂ | SiO₂ | 0.89 | 156.0 | 11.51 | 5.72 | 15.31 | | 0.16 |
| CEX3 | Li_{1.06}Ni_{0.65}Mn_{0.20}Co_{0.15}Zr_{0.00}O₂ | — | — | — | — | — | — | 7.50 | 0.25 |
| EX3.1 | Li_{1.06}Ni_{0.65}Mn_{0.20}Co_{0.15}Zr_{0.00}O₂•WO₃ | WO₃ | 0.25 | — | — | — | — | | 0.19 |
| EX3.2 | Li_{1.06}Ni_{0.65}Mn_{0.20}Co_{0.15}Zr_{0.00}O₂•WO₃•B₂O₃ | WO₃ | 0.25 | 189.1 | 8.8 | 0.9 | 8.8 | | 0.29 |

*A is added during the grinding step of the agglomerated fired body
**A LiₐNi_{b}Co_{c}Mn_{d}DₑO_{f}•A_{G}O_{H} type of general formula means: composition of the active material particles•A oxide(s) particles mixed with said active material powder during the grinding step of the process according to the invention
***— : not applicable

1-17. (canceled)

18. A process of producing a powderous positive electrode active material for lithium ion batteries having particles comprising Li, M, and O, wherein M comprises:
Co in a content x superior or equal to 5.0 mol % and inferior or equal to 40.00 mol %,
Mn in a content y superior or equal to 5.0 mol % and inferior or equal to 40.00 mol %,
A in a content c superior or equal to 0.01 mol % and inferior or equal to 2.00 mol %, wherein A comprises at least one element selected from the group consisting of W, Al and Si,
D in a content z superior or equal to 0 mol % and inferior or equal to 2.00 mol %, wherein D comprises at least one element selected from the group consisting of: Mg, Nb, Zr, B, and Ti, and
Ni in a content of (100-x-y-c-z) mol %, said particles having a Li/M molar ratio superior or equal to 0.98 and inferior or equal to 1.10, the process comprising the steps of:
Preparing a mixture of powders comprising a lithium source, a nickel source, a cobalt source, a manganese source and optionally, a source of D,
firing the mixture of powders at a temperature of at least 300° C. and at most 1000° C. to obtain an agglomerated fired body,
grinding the agglomerated fired body so as to obtain a crushed powder,
said process being characterized in that a source of at the least one of the elements: W, Al, and Si is grinded together with the agglomerated fired body.

19. The process according to claim 18, wherein the crushed powder obtained in the step of grinding the agglomerated fired body has a median particle size D50 which is at least 4.0 μm and which is at most 10.0 μm.

20. The process according to claim 18, wherein the step of grinding the agglomerated fired body is executed in an air classifying mill.

21. The process according to claim 18, wherein the source of said at least one of the elements: W, Al, and Si is a nanometric size oxide powder which is added after the firing step in which the agglomerated fired body is obtained.

22. The process according to claim 18, wherein A comprises Al and the source of Al is Al₂O₃.

23. The process according to claim 22, wherein the source of Al is added in the grinding step in an amount equivalent to a molar content of Al which is superior or equal to 0.08 mol % and inferior or equal to 1.50 mol %, with respect to the sum of the molar contents of Ni, Mn, and Co in the agglomerated fired body.

24. The process according to claim 18, wherein A comprises Si and the source of Si is SiO₂.

25. The process according to claim 24, wherein the source of Si is added in the grinding step in an amount equivalent to a molar content of the Si which is superior or equal to 0.36 mol % and inferior or equal to 1.45 mol %, with respect to the total molar contents of Ni, Mn, and Co in the agglomerated fired body.

26. The process according to claim 18, wherein A comprises W and the source of W is WO₃.

27. The process according to claim 26, wherein the source of W is added in the grinding step in an amount equivalent to a molar content of W which is superior or equal to 0.20 mol % and inferior or equal to 0.35 mol %, with respect to the sum of the molar contents of Ni, Mn, and Co in the agglomerated fired body

28. The process according to claim 18, wherein the lithium source is at least one compound selected from the group consisting of: Li₂CO₃, Li₂CO₃H₂O, LiOH, LiOHH₂O and Li₂O.

29. The process according to claim 18, wherein the crushed powder is the powderous positive electrode active material.

30. The process according to claim 18, wherein 5 mol %≤x≤35 mol % and 5 mol %≤y≤35 mol %,
wherein M comprises B in a content b superior or equal to 0.01 mol % and inferior or equal to 2.00 mol %,
wherein M comprises W in a content w superior or equal to 0.01 mol % and inferior or equal to 2.00 mol %,
wherein M comprises Zr in a content m superior or equal to 0 mol % and inferior or equal to 1.99 mol %,
wherein the step of preparing a mixture of powders comprises mixing a Ni-based precursor, a source of Li, and optionally a source of Zr and A, so as to obtain a first mixture,
wherein, in said step of firing the mixture of powders, the first mixture is said mixture of powders, and said first mixture is sintered at a first temperature of at least 700° C. to obtain a first sintered body,
wherein, in said step of grinding the agglomerated fired body, the agglomerated fired body is said first sintered body, and a source of W is grinded together with the agglomerated fired body, to obtain a crushed powder comprising W,
wherein the process comprises the step of mixing the crushed powder with a source of B to obtain a second mixture,
wherein the process comprises the step of heat-treating the second mixture to a second temperature of at least 300° C. and at most 750° C.

31. A powderous material having particles comprising Li, M, and O, wherein M comprises:
Co in a content x superior or equal to 5.0 mol % and inferior or equal to 40.00 mol %,
Mn in a content y superior or equal to 5.0 mol % and inferior or equal to 40.00 mol %,
A in a content c superior or equal to 0.01 mol % and inferior or equal to 2.00 mol %, wherein A comprises at least one element selected from the group consisting of: W, Al, and Si,
D in a content z superior or equal to 0 mol% and inferior or equal to 2.00 mol %, wherein D comprises at least one element selected from the group consisting of: Mg, Nb, Zr, B, and Ti, and
Ni in a content of (100-x-y-c-z) mol %,
said particles having a Li/M molar ratio superior or equal to 0.98 and inferior or equal to 1.10,
wherein said powderous precursor has a powder flow index of at most 0.30, wherein the flow index is the slope of a straight line fitted to experimental results of measured unconfined failure strengths at several principal consolidating stresses as measured in an annular shear cell of 6 inch diameter and with a volume of 230 cm³.

32. The powderous material according to claim 31, wherein the powderous material is a precursor compound for manufacturing a powderous positive electrode active material,
wherein 5 mol %≤x≤35 mol %, 5 mol %≤y≤35 mol %, equal to 2.00 mol %, .
wherein M comprises W in a content w superior or equal to 0.01 mol % and inferior or equal to 2.00 mol %,
wherein M comprises Zr in a content m superior or equal to 0 mol % and inferior or equal to 2.00 mol %,
wherein said powderous precursor has a powder flow index of inferior to 0.20, and superior to 0.10.

33. The powderous material according to claim 31, wherein the powderous material is a positive electrode active material for lithium ion batteries, wherein the powderous material has a D50 of at least 4.0 μm and at most 10.0 μm, wherein
said powderous material has a flow index of at least 0.10 and at most 0.30, and wherein the D50 is the median particle size of the powderous material.

34. The powderous material according to claim 31, wherein the powderous material is a positive electrode active material for lithium ion batteries, wherein the powderous material has a D50 of at least 4.0 μm and at most 10.0 μm, wherein
said powderous material has a flow index of at least 0.10 and of at most 0.225, wherein the D50 is the median particle size of the powderous material

35. The powderous material according to claim 31, wherein said powderous material has a D50 superior to 6.0 μm and of at most 10.0 μm and a flow index of at least 0.10 and of at most 0.20 or wherein said powderous material has a D50 of at least 4.0 μm and of at most 6.0 μm and a flow index of at least 0.10 and at most 0.30, characterized in that the powderous material is obtainable by the process of claim 18, wherein D50 is the median particle size of the powderous material.
